(19) United States
(12) Patent Application Publication
(10) Pub. No.: US 2014/0292825 A1
(43) Pub. Date: Oct. 2, 2014

(54) MULTI-LAYER DISPLAY APPARATUS AND DISPLAY METHOD USING IT

(71) Applicants: Korea Data Communication Corporation, Seoul; (KR); TI Systems CO. LTD., Seoul (KR); PRIME RESOURCE CORPORATION, Seoul (KR)

(72) Inventors: Tae Sub Kim, Seoul (KR); Jae Hoon Kim, Seoul (KR); Sun Cheol Jeong, Seoul (KR)

(73) Assignees: Korea Data Communications Corporation, Seoul (KR); T1 Systems CO., LTD., Seoul (KR); PRIME RESOURCE CORPORATION, Seoul (KR)

(21) Appl. No.: 13/985,590

(22) PCT Filed: Mar. 28, 2013
(86) PCT No.: PCT/KR2013/002572

§ 371 Date: Aug. 15, 2013

(51) Int. Cl. G09G 3/36

(52) U.S. Cl. CPC G09G 3/3607
USPC 345/690; 345/88

(57) ABSTRACT

The present invention relates to a multi-layer display apparatus and a display method using the same, and more particularly, relates to a multi-layer display apparatus for adjusting a color value and an object size in an overlapping part so as to maintain an original color when a background image displayed on a general LCD panel and an exhibition image displayed on a transparent LCD panel are superimposed in a structure where the general LCD panel and the transparent LCD panel are disposed in order, and a display method using the same. To this end, the multi-layer display apparatus according to the present invention includes a first display panel for displaying a background image, a second display panel disposed in front of the first display panel and displaying an exhibition image, and a control box for correcting a color value and a coordinate value of a pixel position where the background image and the exhibition image are superimposed, and outputting an image reflecting the corrected color value and coordinate value.

### TECHNICAL FIELD

The present invention relates to a multi-layer display apparatus and a display method using the same. More particularly, the present invention relates to a multi-layer display apparatus for adjusting a color value and an object size in an overlapping part so as to maintain an original color when a background image displayed on a general LCD panel and an exhibition image displayed on a transparent LCD panel are superimposed in a structure where the general LCD panel and the transparent LCD panel are disposed in order, and a display method using the same.

### BACKGROUND ART

To promote or introduce a particular product in a showroom, an exhibition hall, or a public place, a media display device for many people is installed.

To enhance entertainment, marketing effect, or display effect, the media display device shows a remarkable image by adopting various computer graphic techniques and thus stimulates viewer's sight and hearing.

The media display device includes a large-scale screen, which is mostly a two-dimensional flat display, and thus cannot provide the illusion of depth or the perspective to the viewer.

While a recent 3D image processing method can be used to show the stereoscopic image to the viewer, the viewer needs to wear 3D glasses. A 3D display device allows to directly view the stereoscopic image with the naked eyes without wearing the 3D glasses, but can cause fatigue and dizziness to the viewer's eye.

On this account, a multi-layer display device for arranging display panels back and forth, displaying a background image on the back display, and displaying an exhibition image on the front display panel is under development so as to provide the perspective or stereoscopic image to the viewer.

However, when the images displayed on the two display panels are superimposed, the colors in the overlapping part are mixed to produce a different color from the original color. As a result, the color difference grows according to a view direction of the viewer and thus the precise and stable stereoscopic image is not provided to the viewer.

### DETAILED DESCRIPTION OF THE INVENTION

### Technical Object of the Invention

Accordingly, an aspect of the present invention is to display an image in an overlapping part of a multi-layer display apparatus, as an original image to a viewer's eye.

Another aspect of the present invention is to stably display an image of an original color regardless of a view direction of a viewer by correcting a color and an object of an image in an overlapping part in a multi-layer display apparatus.

### SUMMARY OF THE INVENTION

A multi-layer display apparatus according to the present invention includes a first display panel for displaying a background image, a second display panel disposed in front of the first display panel and displaying an exhibition image, and a control box for correcting a color value and a coordinate value of a pixel position where the background image and the exhibition image are superimposed, and outputting an image reflecting the corrected color value and coordinate value.

A control box according to the present invention includes an image analysis module for receiving a coordinate value and a color value of each of a background image and an exhibition image, and checking whether the background image and the exhibition image are superimposed, a color correction module for receiving image overlap from the image analysis module and correcting the color value by checking the color value of the overlapping pixel position, an image correction module for receiving the image overlap from the image analysis module and correcting a coordinate value of an object by identifying the object at the overlapping pixel, and a control module for sending the coordinate values and the color values of the background image and the exhibition image to the image analysis module, synthesizing a color correction value and a position correction value input from the color correction module and the image correction module, and instructing to display a corrected image on a first display panel and a second display panel.

A display method of a multi-layer display apparatus according to the present invention includes receiving a coordinate value and a color value of each of a background image displayed on a first display panel and an exhibition image displayed on a second display panel, and checking whether the background image and the exhibition image are superimposed, when the background image and the exhibition image are superimposed, checking and correcting a color value of an overlapping pixel position, correcting a coordinate value of an object by identifying the object of the overlapping pixel position, and synthesizing the corrected color value and the corrected object coordinate value.

### EFFECT OF THE INVENTION

As set forth above, the present invention corrects the color value at the overlapping pixel position of the background image and the exhibition image, adjusts the object size corresponding to the pixel position, and provides the image of the corrected color and position. Thus, the viewer can stably view the image of the original color.

In addition, since the present invention corrects the color using not only the additive color process but also the subtractive color process, it can address the increasing computation which is caused when determining the initial point using only the additive color process. Hence, the computation time taken to correct the color can be shortened.

Further, since not only the color but also the object in the overlapping part are corrected together, it is possible to prevent the meaningless color correction caused by the pixel position mismatch between the two panels.

The brief description of the drawings

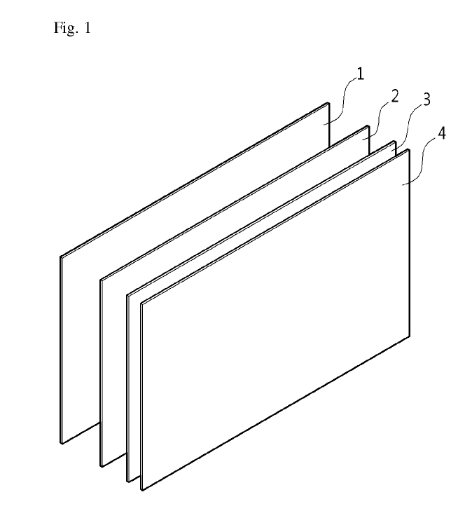

FIG. 1 is a diagram of a display panel structure of a multi-layer display apparatus according to the present invention.

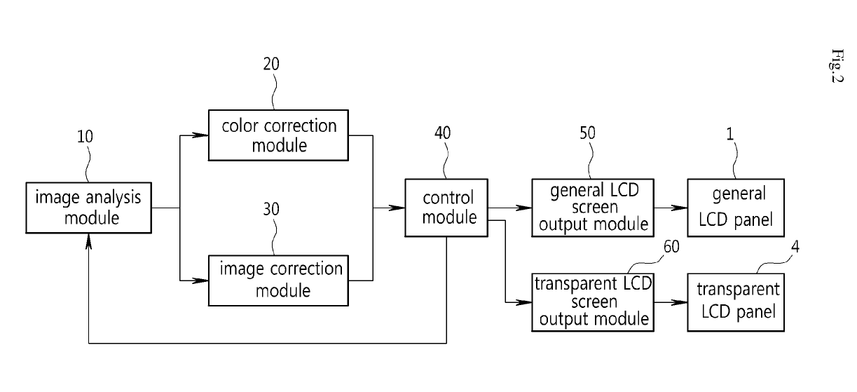

FIG. 2 is a simplified block diagram of a control box in the multi-layer display apparatus according to the present invention.

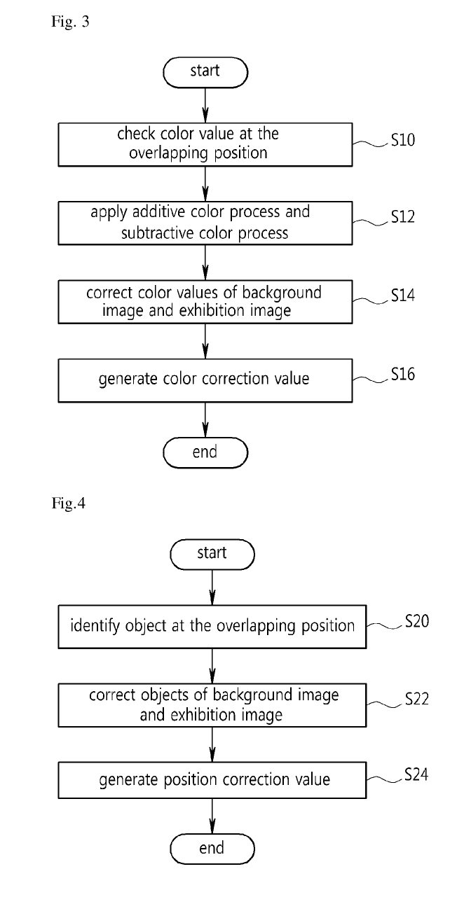

FIG. 3 is a flowchart of a color correcting method in the multi-layer display apparatus according to the present invention.

FIG. 4 is a flowchart of an object correcting method in the multi-layer display apparatus according to the present invention.

### THE BEST EMBODIMENT OF THE INVENTION

Various embodiments of the present invention will now be described in detail with reference to the accompanying drawings. In the following description, specific details such as detailed configuration and components are merely provided to assist the overall understanding of these embodiments of the present invention.

Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

FIG. 1 depicts a display panel structure of a multi-layer display apparatus according to the present invention.

As shown in FIG. 1, the display panel structure of the multi-layer display apparatus includes a general LCD panel 1, a transparent LCD panel 4 disposed in front of the general LCD panel 1, and a retardation film 2 and a haze film 3 interposed between the general LCD 1 and the transparent LCD panel 4. While it is not depicted in FIG. 1, a control box outputs a background image on the general LCD panel 1 and outputs an exhibition image on the transparent LCD panel 4.

The general LCD panel 1 displays the background image by receiving a video signal from the control box, and the transparent LCD panel 4 displays the exhibition image by receiving a video signal from the control box as well. The general LCD panel 1 and the transparent LCD panel 4 can use a commercialized panel.

While the LCD panel is used in this exemplary embodiment of the present invention, a different kind of the display panel may be used. In this case, a first display panel can be installed at the back and a second display panel can be installed in front of the first display panel.

The retardation film 2 can use a film of ¼λ, or ½λ, according to a polarizing plate used in the general LCD panel 1, and the haze film 3 can use a film of various haze rates according to a space between the general LCD panel 1 and the transparent LCD panel 4. When the space between the general LCD panel 1 and the transparent LCD panel 4 is greater than 5 cm, the haze film of 20% can be used. When the space is smaller than 5 cm, the haze film of 30% can be used.

The multi-layer display apparatus according to the present invention displays the background image on the general LCD panel 1 at the back and displays the exhibition image on the transparent LCD panel 4 at the front according to image output control of the control box. Thus, the viewer can feel the illusion of depth or the perspective by viewing the two images at the same time.

FIG. 2 is a simplified block diagram of the control box in the multi-layer display apparatus according to the present invention.

As shown in FIG. 2, the control box includes an image analysis module 10, a color correction module 20, an image correction module 30, a control module 40, a general LCD screen output module 50, and a transparent LCD screen output module 60, and outputs the video signals corresponding to the general LCD panel 1 and the transparent LCD panel 4 respectively.

The image analysis module 10 receives coordinate values and color values of the background image and the exhibition image from the control module 40 and checks whether the background image and the exhibition image are superimposed on the same position. When the background image and the exhibition image are superimposed on the same position, the image analysis module 10 sends the coordinate value overlap to the color correction module 20 and the image correction module 30.

The color correction module 20 receives the coordinate value overlap from the image analysis module 10 and corrects the color value by checking the color value of the overlapping position (pixel). That is, the color correction module 20 calculates a correction value by referring to a color value table which is generated in advance according to an additive color process and a subtractive color process.

The additive color process yields a certain value by mixing three primary colors including the red (R), the green (G), and the blue (B) at various rates. By mixing the three primary colors at various rates, any color light including the white light can be yielded. Based on this principle, the mixing rate of the three primary colors for a particular color is determined.

The subtractive color process yields a certain color by subtracting the red (R), the green (G), and the blue (B) at various rates in the white light. In the subtractive color process, three primary colors include the cyan, the magenta, and the yellow, the cyan is created by subtracting the red (R) in the white light, the magenta is created by subtracting the green (G) in the white light, and the yellow is created by subtracting the blue (B) in the white light. All of the three primary colors of the subtractive color process yield the black.

When the color is corrected using only the additive color process, an initial point problem is prone to increase computations. Hence, the present invention corrects the color using both of the additive color process and the subtractive color process.

For example, when the color value of the background image is the red and the color value of the exhibition image is the blue at the overlapping position of the exhibition image and the background image, the two colors can be mixed to yield the purple to the viewer's eye. When correcting the color value of the background image or the exhibition image, the color correction module 20 calculates the correction value using both of the additive color process and the subtractive color process so that the exhibition image can be viewed as the original blue.

The image correction module 30 receives the coordinate value overlap from the image analysis module 10 and corrects the object by identifying an object at the overlapping position (pixel). That is, the image correction module 30 adjust an object size by correcting the coordinate value of the object based on a physical distance between the general LCD panel 1 and the transparent LCD panel 4.

According to a view direction of the person viewing the screen in the multi-layer display apparatus, the pixel positions of the general LCD panel 1 and the transparent LCD panel 4 vary. Even when the viewer faces the screen at the front, the pixel positions of the general LCD panel 1 and the transparent LCD panel 4 do not match. That is, the pixel (10, 10) of the general LCD panel 1 does not match the pixel (10, 10) of the transparent LCD panel 4. Due to this mismatch of the pixel position, the color correction can be meaningless.

The image correction module 20 according to the present invention corrects the coordinate value of the object by reducing the object size on the transparent LCD panel 4 and increasing the object size on the general LCD panel 1 based on the physical distance between the panels. Hence, the effect of the color correction can be maintained even when the two panels are altered vertically or horizontally at its fabrication phase or even when the two panels are moved vertically or horizontally according to the viewpoint of the viewer.

The control module 30 instructs to output the image by sending the coordinate values and the color values of the background image and the exhibition image to the general LCD screen output module 50 and the transparent LCD screen output module 60.

The control module 40 according to the present invention sends the coordinate values and the color values of the background image and the exhibition image to the image analysis module 10. The control module 40 synthesizes the color correction value and the position correction value input from the color correction module 20 and the image correction module 30, sends the synthesized value to the general LCD screen output module 50 and the transparent LCD screen output module 60, and thus instructs to output the corrected image.

The general LCD screen output module 50 outputs the background image on the general LCD panel 1 according to the instruction of the control module 40.

The transparent LCD screen output module 60 outputs the exhibition image on the transparent LCD panel 4 according to the instruction of the control module 40.

FIG. 3 depicts a color correcting method in the multi-layer display apparatus according to the present invention.

Referring to FIG. 3, the method receives the coordinate values and the color values of the background image displayed on the first display panel and the exhibition image displayed on the second display panel, checks whether the background image and the exhibition image overlap with each other, and checks the color value at the overlapped pixel position when the background image and the exhibition image are superimposed (S10).

Next, the method performs the calculation by applying the additive color process and the subtractive color process to the color value of the overlapped pixel position (S12), corrects the color values of the background image and the exhibition image (S14), and generates the color correction value at the overlapped pixel position of the background image and the exhibition image (S16). The color correction value is input to the control module 40.

FIG. 4 depicts an object correcting method in the multi-layer display apparatus according to the present invention.

Referring to FIG. 4, the method receives the coordinate values and the color values of the background image displayed on the first display panel and the exhibition image displayed on the second display panel, checks whether the background image and the exhibition image overlap with each other, and identifies the object at the overlapped pixel position when the background image and the exhibition image are superimposed (S20).

Next, the method corrects the coordinate value of the object by adjusting the object size at the overlapped pixel position (S22), and generates the position correction value at the overlapped pixel position of the background image and the exhibition image (S24). The position correction value is input to the control module 40.

The color correction value (the corrected color value) and the position correction value (the coordinate value of the corrected object) are synthesized by the control module 40 per background image and exhibition image, and output to the first display panel and the second display panel respectively.

Meanwhile, the display method of the multi-layer display apparatus can be implemented as a software program and recorded on a computer-readable recording medium.

For example, the recording medium can include an internal type of each reproducing device such as hard disc, flash memory, RAM, and ROM, and an external type such as optical disc including CD-R and CD-RW, compact flash card, smart media, memory stick, and multimedia card.

In this case, the program recorded on the computer-readable recording medium can fulfill the display method of the multi-layer display apparatus, which includes receiving the coordinate values and the color values of the background image displayed on the first display panel and the exhibition image displayed on the second display panel, checking whether the background image and the exhibition image overlap with each other, checking and correcting the color value at the overlapped pixel position when the background image and the exhibition image are superimposed, identifying the object at the overlapped pixel position and correcting the coordinate value of the object, and synthesizing the corrected color value and the corrected object coordinate value.

The functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous.

Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

While the invention has been shown and described with reference to certain exemplary embodiments thereof, it will be understood by those skilled in the art that various changes in form and details may be made therein without departing from the spirit and scope of the invention as defined by the appended claims and their equivalents.

### INDUSTRIAL APPLICABILITY

The multi-layer display apparatus according to the present invention can be installed in a place where a great number of people are gathered, such as showroom, exhibition hall, subway, train station, or square, and be used to provide the user with the vivid stereoscopic and image with the illusion of depth. By use of such a multi-layer display apparatus, a public institution can quite effectively promote or advertize a policy or a system and a company can effectively promote or advertize a particular project or service. Therefore, the multi-layer display apparatus can be useful across all industries.

1. A multi-layer display apparatus comprising:
a first display panel for displaying a background image;
a second display panel disposed in front of the first display panel and displaying an exhibition image; and
a control box for correcting a color value and a coordinate value of a pixel position where the background image and the exhibition image are superimposed, and outputting an image reflecting the corrected color value and coordinate value.

2. The multi-layer display apparatus of claim 1, wherein the control box corrects the color value of an overlapping pixel position using an additive color process and a subtractive color process.

3. The multi-layer display apparatus of claim 1, wherein the control box adjusts an object size of the overlapping pixel position based on a physical distance between the first display panel and the second display panel.

4. A control box comprising:
an image analysis module for receiving a coordinate value and a color value of each of a background image and an exhibition image, and checking whether the background image and the exhibition image are superimposed;
a color correction module for receiving image overlap from the image analysis module and correcting the color value by checking the color value of the overlapping pixel position;
an image correction module for receiving the image overlap from the image analysis module and correcting a coordinate value of an object by identifying the object at the overlapping pixel; and
a control module for sending the coordinate values and the color values of the background image and the exhibition image to the image analysis module, synthesizing a color correction value and a position correction value input from the color correction module and the image correction module, and instructing to display a corrected image on a first display panel and a second display panel.

5. The control box of claim 4, wherein the color correction module corrects the color value of the overlapping pixel position using an additive color process and a subtractive color process.

6. The control box of claim 4, wherein the image correction module adjusts an object size of the overlapping pixel position based on a physical distance between the first display panel and the second display panel.

7. A display method of a multi-layer display apparatus, comprising:
receiving a coordinate value and a color value of each of a background image displayed on a first display panel and an exhibition image displayed on a second display panel, and checking whether the background image and the exhibition image are superimposed;
when the background image and the exhibition image are superimposed, checking and correcting a color value of an overlapping pixel position;
correcting a coordinate value of an object by identifying the object of the overlapping pixel position; and
synthesizing the corrected color value and the corrected object coordinate value.

8. The display method of claim 7, wherein the correcting of the color value corrects the color value of the overlapping pixel position using an additive color process and a subtractive color process.

9. The display method of claim 7, wherein the correcting of the coordinate value of the object adjusts an object size of the overlapping pixel position based on a physical distance between the first display panel and the second display panel.

10. The display method of claim 9, wherein an object size on the first display panel is increased and an object size on the second display panel is decreased.

11. A computer-readable recording medium storing a program for executing the method according to claim 7.

12. A computer-readable recording medium storing a program for executing the method according to claim 8.

13. A computer-readable recording medium storing a program for executing the method according to claim 9.

14. A computer-readable recording medium storing a program for executing the method according to claim 10.
